(19) United States
(12) Patent Application Publication
(10) Pub. No.: US 2012/0155438 A1
(43) Pub. Date: Jun. 21, 2012

(54) METHOD OF REORDERING AND REASSEMBLING PACKET DATA IN RADIO LINK CONTROL LAYER

(75) Inventors: Jae Wook SHIN, Daejeon (KR); Kwang Ryul JUNG, Daejeon (KR); Ae Soon PARK, Daejeon (KR)

(73) Assignee: Electronics and Telecommunications Research Institute, Daejeon (KR)

(21) Appl. No.: 13/332,995

(22) Filed: Dec. 21, 2011

(30) Foreign Application Priority Data
Dec. 21, 2010 (KR) 10-2010-0131992

(51) Int. Cl. H04W 72/04

(52) U.S. Cl. 370/336

(57) ABSTRACT

A method includes recognizing, by an RLC entity of a reception side, a transmission time interval (TTI) start time, initializing a count of the number of PDUs processed in a TTI, determining whether the reordering timer has expired, performing a procedure of reassembling RLC service data units (SDUs) and transmitting the reassembled RLC SDUs to an upper layer and updating the reordering timer when the reordering timer has expired, performing the procedure and updating the reordering timer when an RLC PDU received from a lower layer is an RLC PDU which should be received by retransmission of a transmission side before reordering timer expiration, and processing RLC SDUs received from the upper layer, wherein the procedure limits the number of RLC PDUs to be processed within a TTI using the count of the number of PDUs to be processed within the TTI.

### CLAIM FOR PRIORITY

This application claims priority to Korean Patent Application No. 10-2010-0131992 filed on Dec. 21, 2010 in the Korean Intellectual Property Office (KIPO), the entire contents of which are hereby incorporated by reference.

### BACKGROUND

1. Technical Field

Example embodiments of the present invention relate to a method of reordering and reassembling packet data, and more particularly, to a method of smoothly reordering and reassembling packet data through load distribution in a radio link control (RLC) layer in a Long Term Evolution (LTE)-Advanced next-generation mobile communication system.

2. Related Art

In a radio interface of a 3rd Generation Partnership Project (3GPP) mobile communication system of the related art, an RLC layer ensures reliable transmission of upper-layer data. For this, the RLC layer provides functions of segmentation and reassembly, in-sequence transfer, and automatic repeat request (ARQ)-based retransmission of an upper layer service data unit (SDU).

RLC protocol data units (PDUs) are sequentially transmitted and received between a transmission side and a reception side if no loss occurs. However, when retransmission by hybrid-ARQ (HARQ) or ARQ is performed due to loss on a radio data frame in which the RLC PDUs are transmitted, the reception side may receive the RLC PDUs out of order. The RLC reception side is configured to reorder the PDUs received out of order as described above, reassemble RLC SDUs from the reordered RLC PDUs, and transfer the reassembled RLC SDUs to the upper layer in order.

The RLC reception side senses whether a specific PDU has been lost by comparing sequence numbers (SNs) of adjacently received RLC PDUs. If the PDU has been lost, it starts up a reordering timer and waits for the lost PDU to be retransmitted by the transmission side and received for a timer period. If the lost packet is received before the reordering timer expires, the reordering timer is stopped, RLC SDUs are reassembled from all RLC PDUs currently sequentially received, and the reassembled RLC SDUs are transferred to an upper layer in order. If the reordering timer expires in a state in which the lost PDU is not received, RLC SDUs are reassembled by using previously received RLC PDUs having SNs greater than that of the lost RLC PDU and transferred to the upper layer.

In general, a physical (PHY) layer, a medium access control (MAC) layer, and an RLC layer of a 3GPP mobile communication system operate in synchronization with a transmission time interval (TTI) (for example, a TTI of 1 msec is used in LTE and LTE-Advanced systems). That is, because uplink and downlink data transmission is performed in TTI time units, data to be transmitted and received in a specific TTI should be completely processed in the TTI. If an amount of work to be processed in a specific TTI is large and exceeds a given TTI time, this affects work to be processed in the next TTI and a problem of a packet processing delay or packet loss is caused.

If a reordering timer expires in a specific TTI in the RLC layer or retransmitted PDUs are received out of order and reordered, overload may occur when a reassembly operation on a plurality of RLC PDUs should be simultaneously performed. In this case, when it is desired to complete an RLC SDU reassembly operation during one TTI, packet transmission and reception may be impossible in the next TTI due to an excess of a TTI time and consequently packet loss may be caused.

In particular, recently, carrier aggregation (CA) or multiple input multiple output (MIMO) technology has been widely used for high-speed data transmission. In this case, the number of transport blocks transmitted/received in one TTI may be at least one in each of uplink and downlink. When reordering and reassembly events are generated in a state in which the number of PDUs to be basically processed by the RLC layer in one TTI is large, RLC SDU reassembly load becomes significantly heavy. Accordingly, a more effective processing method for reducing the heavy load is necessary.

### SUMMARY

Accordingly, example embodiments of the present invention are provided to substantially obviate one or more problems due to limitations and disadvantages of the related art.

Example embodiments of the present invention provide a packet reordering and reassembly method of smoothly reordering and reassembling packet data through load distribution in an RLC layer in an LTE-Advanced next-generation mobile communication system or the like.

In some example embodiments, a method of distributing and performing reordering of protocol data units (PDUs) and reassembly of service data units (SDUs) in radio link control (RLC) layer over many transmission time intervals (TTIs), includes: recognizing, by an RLC entity of a reception side, a TTI start time; initializing a count of the number of PDUs to be processed in a TTI; processing a reordering timer by determining whether the reordering timer has expired, and performing a procedure of reassembling RLC service data units (SDUs) and transmitting the reassembled RLC SDUs to an upper layer and updating the reordering timer when the reordering timer has expired; processing reception by performing the procedure of reassembling RLC service data units (SDUs) and transmitting the reassembled RLC SDUs to an upper layer and updating the reordering timer when an RLC PDU received from a lower layer is an RLC PDU which should be received by retransmission from a transmission side before reordering timer expiration; and processing transmission by processing RLC SDUs received from the upper layer, wherein the procedure limits the number of RLC PDUs to be processed within a TTI using the count of the number of PDUs to be processed within the TTI.

In the method, the recognizing may includes: receiving, by the RLC entity of the reception side, a TTI interrupt.

In the method, a time allocated to the transmission processing during one TTI and a time allocated to the reception processing may be configured to be variable.

In the method, the transmission processing may include: receiving RLC SDUs from the upper layer; encoding the RLC SDUs into an RLC PDU; and transferring the RLC PDU to the lower layer.

In the method, the procedure of reassembling RLC SDUs and transmitting the reassembled RLC SDUs to an upper layer may reassemble RLC SDUs by using RLC PDUs of which the number is the number of RLC PDUs to be processed for the reassembly of RLC SDUs within a TTI, and transferring the reassembled RLC SDUs to the upper layer. At this time, the number of RLC PDUs to be processed for the reassembly of RLC SDUs within the TTI may be calculated on the basis of a time taken to assemble RLC SDUs from one PDU and transfer the assembled RLC SDUs to the upper layer. In addition, the number of RLC PDUs to be processed for the reassembly of RLC SDUs within the TTI may be calculated by a sum of a number of RLC PDUs to be processed basically within the TTI and a number of RLC PDUs passed to the TTI without being processed in a previous TTI due to load distribution.

In the method, the procedure of reassembling RLC SDUs and transmitting the reassembled RLC SDUs to an upper layer may include: initializing a parameter for designating a range of a PDU sequence number (SN) indicating an RLC PDU to be processed within the TTI; reassembling RLC SDUs by using RLC PDUs of which the number is the number of RLC PDUs to be processed for the reassembly of RLC SDUs within the TTI in the range of the PDU SN and transferring the reassembled RLC SDUs to the upper layer; and setting an SN of a first RLC PDU to be processed in the next TTI. At this time, the reassembling may include: determining whether to perform additional reassembly based on the number of currently processed RLC PDUs and SNs of the currently processed RLC PDUs; reassembling RLC SDUs if the additional reassembly is determined to be performed, transmitting the reassembled RLC SDUs to the upper layer, designating an SN of the next PDU to be processed, incrementing the number of currently processed RLC PDUs, and iterating from the determining of whether to perform additional reassembly; and setting an SN of a first RLC PDU to be processed in the next TTI if no additional reassembly is determined to be performed.

In other example embodiments, a method of reassembling RLC SDUs of an RLC layer and transmitting the reassembled RLC SDUs to an upper layer in which the number of RLC PDUs to be processed in one TTI is limited for load distribution when the PDUs of the RLC layer are reordered and the SDUs of the RLC layer reassembled, includes: initializing a parameter for designating a range of a PDU SN indicating an RLC PDUs to be processed within the TTI; reassembling RLC PDUs of which the number is the number of RLC PDUs to be processed for the reassembly of RLC SDUs within a TTI in the range of the PDU SN and transferring the reassembled RLC SDUs to the upper layer; and setting an SN of a first RLC PDU to be processed in the next TTI.

In the method, the reassembling may include: determining whether to perform additional reassembly based on the number of currently processed RLC PDUs and SNs of the currently processed RLC PDUs; reassembling RLC SDUs while incrementing the SN of the currently processed RLC PDU if the additional reassembly is determined to be performed, transmitting the reassembled RLC SDUs to the upper layer, designating an SN of the next PDU to be processed, incrementing the number of currently processed RLC PDUs, and iterating from the determining whether to perform additional reassembly; and setting an SN of a first RLC PDU to be processed in the next TTI if no additional reassembly is determined to be performed.

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram illustrating a radio interface protocol structure in an LTE-Advanced system;

FIG. 2 is a sequence diagram showing a data transmission flow when retransmission succeeds in an RLC layer;

FIG. 3 is a sequence diagram showing a data transmission flow when retransmission fails in the RLC layer;

FIG. 4 is a conceptual diagram showing a TTI-based operation flow of an RLC entity;

FIG. 5 is a flowchart illustrating a packet reordering and reassembly method according to an example embodiment of the present invention; and

FIG. 6 is a flowchart illustrating a procedure of reassembling RLC SDUs and transferring the reassembled RLC SDUs to an upper layer in the packet reordering and reassembly method according to an example embodiment of the present invention.

### DESCRIPTION OF EXAMPLE EMBODIMENTS

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, A, B, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments of the present invention will be described in detail with reference to the accompanying drawings.

Packet Reordering and Reassembly Procedure of LTE-Advanced System

A data transmission failure on a radio interface of the LTE-Advanced system of the related art leads to retransmission and out-of-order reception of RLC PDUs. The retransmission is performed by HARQ in a PHY/MAC layer and ARQ in an RLC layer.

If the PDUs are received out of order, the RLC layer sequentially reorders RLC PDUs and reassembles RLC SDUs and transfers the reassembled RLC SDUs to an upper layer. In general, the RLC layer performs a data transmission/reception operation in synchronization with a TTI along with the lower PHY/MAC layer. Accordingly, if the data transmission/reception operation during a specific TTI is time-consuming and exceeds the TTI, the data transmission/reception operation to be performed in the next TTI is not performed normally and hence data loss occurs.

If no packet loss occurs, an operation to be performed by the RLC layer includes a data transmission operation and a data reception operation. However, when a PDU reordering operation and an SDU reassembly operation are performed in a specific TTI with retransmission due to packet loss, an additional data processing operation should be performed due to reordering and reassembly in the TTI. Accordingly, there is a problem in that a packet processing time may be greater than other TTIs in which general data transmission/reception is performed and the processing time may exceed one TTI when the processing time is excessively long.

Hereinafter, a method of reordering and reassembling packet data in an RLC layer according to example embodiments of the present invention for addressing a problem occurring in a method of reordering and reassembling packet data in an LTE system of the related art will be described with reference to the accompanying drawings.

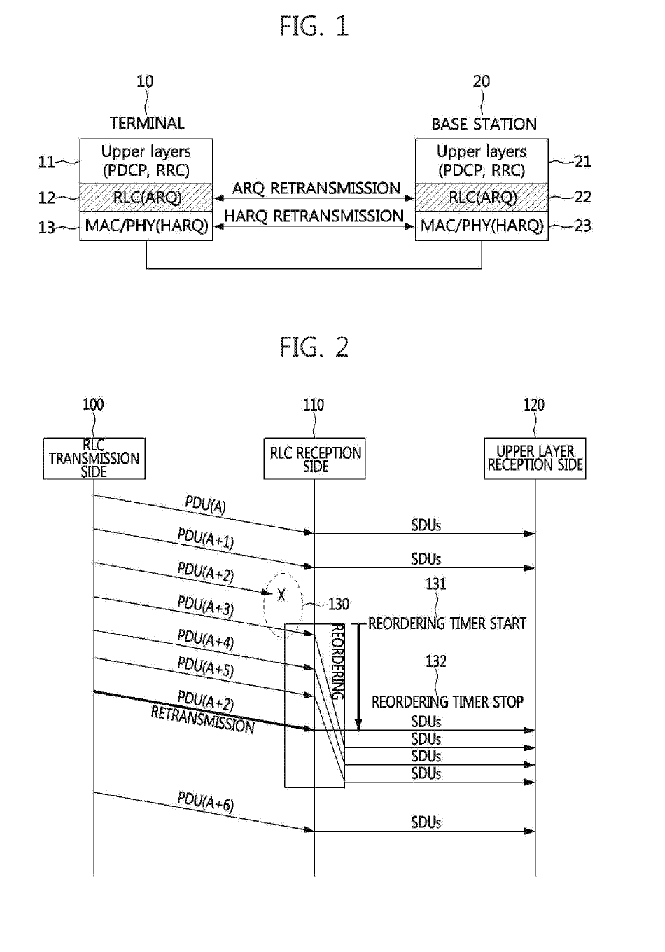

FIG. 1 is a conceptual diagram illustrating a radio interface protocol structure in an LTE-Advanced system.

Referring to FIG. 1, radio interfaces of an LTE-Advanced system include PHY/MAC layers 13 and 23, RLC layers 12 and 22, and upper layers 11 and 21.

The upper layers 11 and 21 for the RLC layers include a packet data convergence protocol (PDCP) layer and a radio resource control (RRC) layer. The RLC and MAC/PHY layers ensure reliable data transfer to the upper layer. For this, the RLC layer provides a retransmission function by ARQ and the PHY/MAC layer provides a retransmission function by HARQ.

Here, operations of the RLC layers 12 and 22 of transmission and reception sides will be described in further detail. An RLC entity of the transmission side configures an RLC PDUs by segmenting RLC SDUs received from the upper layer of the transmission side and adding an RLC header to the RLC PDUs, and transmits the RLC PDU to an RLC entity of the reception side. The RLC entity of the reception side separates the RLC header from the received RLC PDU, configures RLC SDUs by sequentially reassembling RLC SDU segments included in the received RLC PDUs, and sequentially transfers the RLC SDUs to the upper layer.

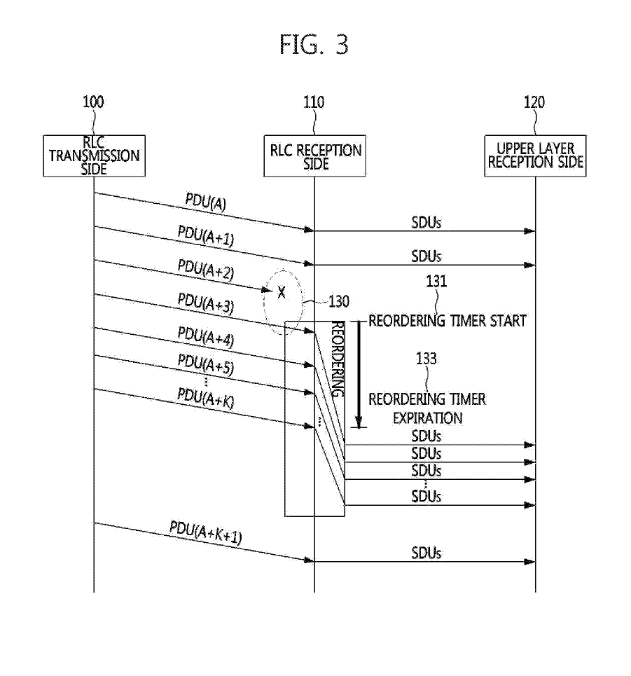

FIGS. 2 and 3 are sequence diagrams illustrating a data transmission flow when retransmission succeeds in the RLC layer and a data retransmission flow when retransmission fails in the RLC layer.

FIG. 2 is a sequence diagram showing the data transmission flow when the retransmission succeeds in the RLC layer.

If the RLC entity of the reception side senses loss of an RLC PDU, for example, if the RLC entity of the reception side receives a PDU having SN (A+3) while waiting for a PDU having SN (A+2) to be received, the RLC entity of the reception side starts up a reordering timer and waits for the PDU having SN (A+2) to be received without reassembling SDU by using currently received PDUs.

Thereafter, the reordering timer is terminated if the PDU having SN (A+2) is received after a PDU having SN (A+5) is received, RLC SDUs are assembled after PDUs sequentially received from the PDU having SN (A+2) to the PDU having SN (A+5) are reordered, and the RLC SDUs are transferred to the upper layer.

FIG. 3 is a sequence diagram showing the data transmission flow when the retransmission fails in the RLC layer.

A lost RLC PDU may be retransmitted by a retransmission function of the transmission side, but the retransmission may fail in some cases.

When sensing PDU loss (130), the RLC entity of the reception side starts up the reordering timer (131) and waits for the lost RLC PDU to be received in a timer operation period. Unless a lost packet is received until the reordering timer expires (133), RLC SDUs are assembled from RLC PDUs sequentially received after the lost PDU and sequentially transferred to the upper layer.

That is, if the reordering timer expires in a state in which a PDU having SN (A+2) has not been received and a PDU having SN (A+K) has been received in FIG. 3, the RLC entity of the reception side assembles RLC SDUs from RLC PDUs having SNs (A+3) to (A+K) and transfers the RLC SDUs to the upper layer.

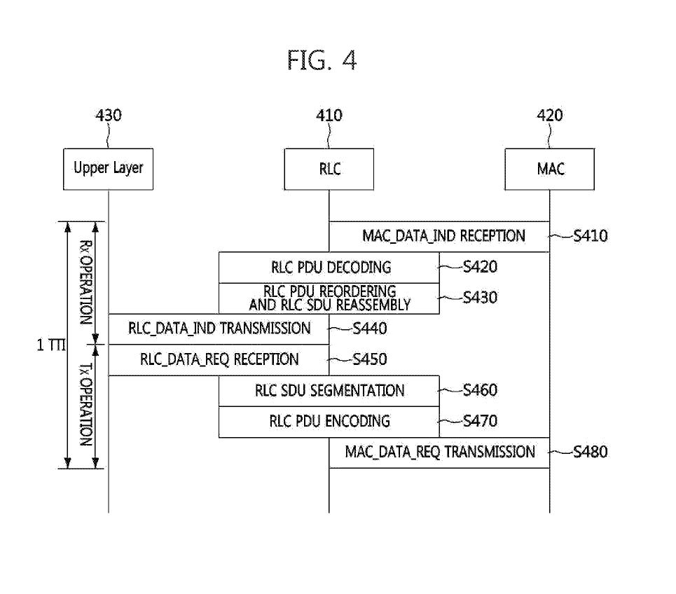

FIG. 4 is a conceptual diagram showing a TTI-based operation flow of an RLC entity.

Referring to FIG. 4, the RLC entity/layer operates in synchronization with a TTI along with the MAC/PHY layer as the lower layer. A TTI value differs according to a mobile communication system, and has a value of 1 msec in a 3GPP LTE-Advanced system. The RLC entity performs data transmission and reception operations during a TTI of 1 msec.

Although operations implemented in order of reception (Rx) and transmission (Tx) are illustrated in FIG. 4, operations may be implemented in order of Tx and Rx.

In the reception operation, an RLC entity/layer 410 receives RLC PDUs from a MAC entity/layer 420 through a MAC_DATA_IND primitive (S410). Because many logical channels may be multiplexed into one MAC transport block (TB) and transmitted or many MAC TBs may be transmitted in one TTI when CA or MIMO technology is used for high-speed transmission, the RLC layer should process many RLC PDUs in one TTI.

The RLC entity/layer decodes the received PDUs (S420). If the PDUs are received in order, RLC SDUs are reassembled from RLC SDU segments included in the PDUs (S430), and transmitted to an upper layer 430 using an RLC_DATA_IND primitive (S440).

In the transmission operation, the RLC entity/layer 410 receives the RLC SDUs from the upper layer 130 through an RLC_DATA_REQ primitive (S450). In addition, RLC SDUs are segmented according to a size of a radio resource allocated to a transmission link (S460) and encoded into an RLC PDUs (S470). The RLC PDU after encoding is transmitted to the MAC layer as a lower layer by a MAC_DATA_REQ primitive (S480). As in the reception operation, many logical channels may be multiplexed into one MAC TB or many RLC PDUs may be configured in one TTI when CA or MIMO technology is used.

As described above, the data transmission/reception operation in the RLC layer should be completed in a period of one TTI.

Accordingly, when the data transmission/reception operation is delayed at the time of TTI=k and exceeds the above-described TTI time, this affects the data transmission/reception operation of TTI=k+1, leading to an internal data processing failure.

Of course, if RLC PDUs are sequentially received without loss, the reception operation may be sufficiently completed in one TTI. However, if a PDU is lost and received after several TTIs or the reordering timer expires, the reordering and reassembly operations may additionally occur and all data reception operations may not be completed in one TTI. In particular, because the number of received and buffered RLC PDUs until the timer expires increases in proportion to a reordering timer value, a processing time increases when reordering and reassembly are performed.

### Packet Reordering and Reassembly Method According to Example Embodiment of Present Invention

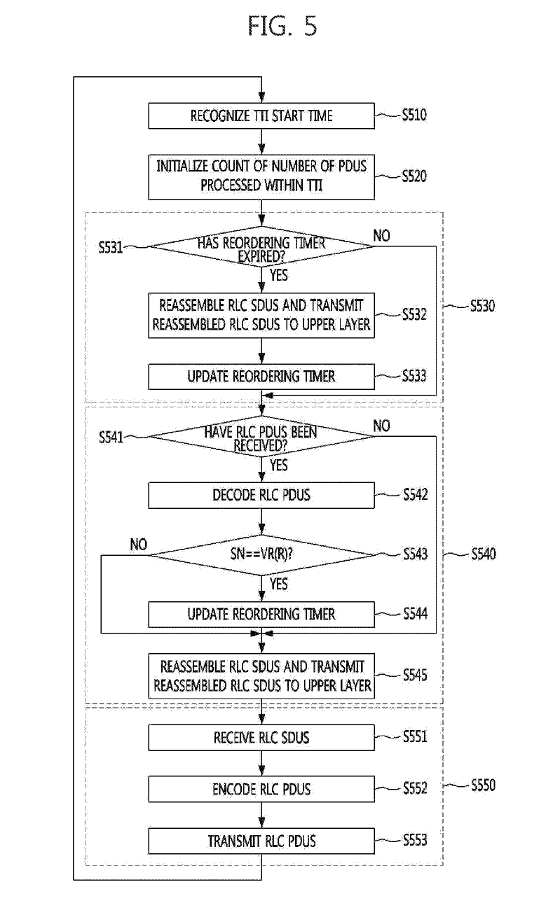

FIG. 5 is a flowchart illustrating the packet reordering and reassembly method according to the example embodiment of the present invention.

The packet reordering and reassembly method according to the example embodiment of the present invention may include step S510 of recognizing, by the RLC entity of the reception side, a TTI start time, step S520 of initializing a count of the number of PDUs processed in a TTI, reordering timer processing step S530, reception processing step S540, and transmission processing step S550.

Step S510 of recognizing, by the RLC entity of the reception side, a TTI start time is the step of starting the packet reordering and reassembly method through load distribution according to the example embodiment of the present invention. In general, the RLC entity of the reception side may be configured to recognize the TTI start time by receiving a TTI interrupt.

Next, in step S520 of initializing the count of the number of PDUs processed for the reassembly of the SDU in the TTI, the RLC entity of the reception side initializes a parameter (for example, numPduReassembled) indicating the number of PDUs on which a reassembly operation is completed during a TTI to 0 (S520).

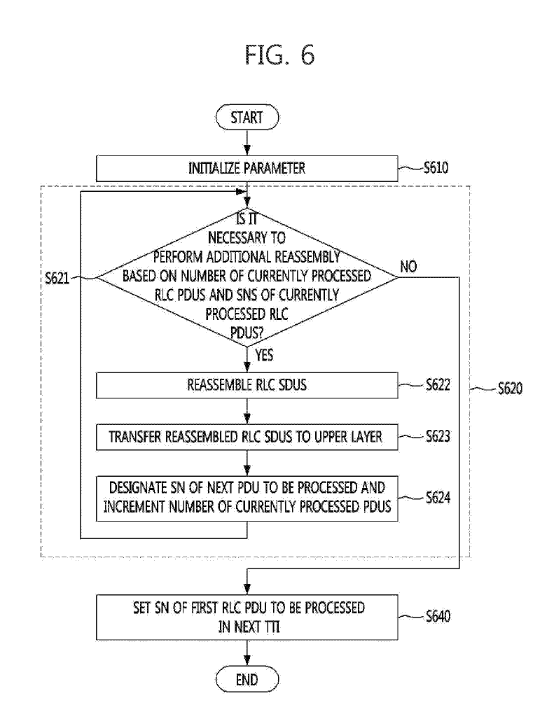

The parameter “numPduReassembled” will be described later as a parameter to be used to count the number of PDUs processed for the reassembly of the SDU within a TTI in a procedure of reassembling RLC SDUs and transmitting the reassembled RLC SDUs to the upper layer to be described later through FIG. 6.

Next, reordering timer processing step S530 is the step of determining whether the reordering timer has expired and performing the procedure of reassembling the RLC SDUs and transmitting the reassembled RLC SDUs to the upper layer and updating the reordering timer when the reordering timer has expired.

That is, it is checked whether the reordering timer has expired (S531) in reordering timer expiration processing step S530. If the reordering timer has not expired in step S531, the process directly proceeds to reception processing step S540. If the reordering timer has expired, a procedure of reassembling RLC SDUs from RLC PDUs received continuously from a PDU having SN VR(R)+1 and transferring the reassembled RLC SDUs to the upper layer (S532) is performed. Here, SN VR(R) is an SN of a PDU of which transmission has failed, for example, an SN indicating PDU(A+2) of which transmission has failed in the examples described with reference to FIGS. 3 and 4. The reordering timer is updated after a reordering and reassembly-related operation (S533).

At this time, the reordering timer is restarted when there is an additional lost RLC PDU, and the reordering timer is stopped when there is no lost RLC PDU.

Next, reception processing step S540 is the reception processing step of performing the procedure of reassembling the RLC SDUs and transmitting the reassembled RLC SDUs to the upper layer, and updating the reordering timer, when an RLC PDU received from the lower layer should be received by retransmission from the transmission side before the reordering timer expires.

That is, in reception processing step S540, it is checked whether data (RLC PDUs) is received from the lower layer by a MAC_DATA_IND primitive (S541). When the MAC_DATA_IND primitive is received and the data is received from the lower layer, an RLC header is decoded from the RLC PDU and an SN is extracted (S542). It is determined whether an SN of the RLC PDU is a minimum SN (VR(R)) to be received (S543). If the SN of the RLC PDU is the minimum SN (VR(R)) to be received, the reordering timer update procedure (S544) is performed to stop or restart the reordering timer. Next, a procedure of assembling RLC SDUs from RLC PDUs received continuously from a PDU having SN VR(R) and transferring the assembled RLC SDUs to the upper layer (S545) is performed.

As described above, the procedure of reassembling the RLC SDUs and transmitting the reassembled RLC SDUs to the upper layer is performed in step S532 when the reordering timer has expired and step S545 when the RLC PDU having SN VR(R) has been normally received (when the RLC PDU having SN VR(R) has been received by retransmission before reordering timer expiration). The procedure is distributed and performed over many TTIs because the entire reassembly operation to be performed in one TTI may exceed one TTI.

That is, the procedure of reassembling the RLC SDUs and transmitting the reassembled RLC SDUs to the upper layer is operated by a method of limiting the number of RLC PDUs processed within a TTI using a count of the number of PDUs processed within the TTI and distributing load in many PDUs without processing all RLC PDUs within one TTI. The procedure of reassembling the RLC SDUs and transmitting the reassembled RLC SDUs to the upper layer according to an example embodiment of the present invention will be described later in detail with reference to FIG. 6.

Next, transmission processing step S550 includes step S551 of receiving an RLC_DATA_REQ primitive from the upper layer, step S552 of encoding an RLC PDUs, and step S553 of transmitting a MAC_DATA_REQ primitive to the lower layer.

At this time, a time to be used in transmission processing step S550, that is, a time to be used for data transmission, may be a fixed time allocated within one TTI, or may variably use a time to be used in reception processing step S540, that is, the remaining time after use in a data reception operation.

Because an operation by a reordering timer and a basic data reception operation are performed in a first half of the TTI when the transmission time is used in a variable mode, a time available in the data transmission operation is also variable and restrictive. Accordingly, the data transmission procedure may be configured to be performed within the remaining time after use in the data reception operation in one TTI. That is, transmission processing step S550 in which data is transmitted to the lower layer by MAC_DATA_REQ by encoding an RLC PDU after calculating the number of RLC_DATA_REQ primitives to be processed in a range that does not exceed the remaining time may be configured.

FIG. 6 is a flowchart illustrating a procedure of reassembling RLC SDUs and transferring the reassembled RLC SDUs to the upper layer in the packet reordering and reassembly method according to an example embodiment of the present invention.

The procedure of reassembling RLC SDUs and transferring the reassembled RLC SDUs to the upper layer illustrated in FIG. 6 includes steps S532 and S545 of reassembling RLC SDUs and transferring the reassembled RLC SDUs to the upper layer described with reference to FIG. 5. The procedure may include step S610 of initializing a parameter for designating a range of a PDU SN indicating an RLC PDU to be processed for the reassembly within a TTI, step S620 of reassembling RLC SDUs by using RLC PDUs of which the number is the number of RLC PDUs to be processed for the reassembly of RLC SDUs within the TTI and transferring the reassembled RLC SDUs to the upper layer, and step S630 of setting an SN of a first RLC PDU to be processed within the next TTI.

Step S610 of initializing the parameter for designating the range of the PDU SN indicating the RLC PDUs to be processed within the TTI is the step of initializing a parameter for designating an SN range of RLC PDUs to be newly processed by reordering timer expiration or RLC data reception.

For example, if the range of the PDU SN indicating the RLC PDUs to be processed for the reassembly within the TTI is firstSn to lastSn, firstSn indicates an SN of a first RLC PDU to be processed and lastSn indicates an SN of a last RLC PDU to be processed.

In addition, the maximum number of PDUs capable of being processed for the reassembly of SUDs in one TTI is denoted by MaxNumPduReassembled, the number of PDUs currently processed within a TTI is denoted by numPduReassembled, and a parameter for designating an SN of the next RLC PDU to be processed within a TTI is denoted by nextSn. An initial value of nextSn is set to a smaller value between firstSn and nextSnReassembled.

Next, step S620 includes step S621 of determining whether to perform additional reassembly based on the number of currently processed RLC PDUs and SNs of the currently processed RLC PDUs, step S622 of reassembling RLC SDUs while incrementing an SN of the currently processed RLC PDU if the additional reassembly is determined to be performed, step S623 of transmitting the reassembled RLC SDUs to the upper layer, step S624 of designating an SN of the next PDU to be processed and incrementing the number of RLC PDUs after step S623, iterating additional reassembly determination step S621, and step S630 of setting an SN of a first RLC PDU to be processed in the next TTI if no additional reassembly is determined to be performed.

In step S621 of determining whether to perform additional reassembly on the basis of the number of currently processed RLC PDUs and SNs of the currently processed RLC PDUs, it is determined whether numPduReassembled<MaxNumPduReassembled and nextSn<=lastSn every time an RLC PDU is processed.

Only if numPduReassembled<MaxNumPduReassembled and nextSn<=lastSn in step S621, RLC SDUs are reassembled from a PDU having nextSn (S622), and the reassembled RLC SDUs are transferred to the upper layer through an RLC_DATA_IND primitive (S623).

Thereafter, a value of numPduReassembled is incremented by 1 and nextSn is set to indicate an SN of the next RLC PDU to be assembled (S624). In this case, in general, nextSn becomes a value incremented by 1. When the process proceeds to step S621 after step 624, additional reassembly determination step S621 and reassembly steps S622 to S624 are iterated.

If numPduReassembled>=MaxNumPduReassembled and nextSn>lastSn in step S621, the process proceeds to step S630 of setting an SN of a first RLC PDU to be processed in the next TTI. That is, a reassembly operation from an RLC PDU is stopped and a value of nextSnAssembled for designating an SN of a first PDU to be processed in the next TTI is set to a value of nextSn.

That is, RLC SDUs are assembled only from PDUs of which the number is the maximum number of PDUs denoted by MaxNumPduReassembled in one TTI when the procedure of reassembling RLC SDUs and transferring the reassembled RLC SDUs to the upper layer described above with reference to FIG. 6 is followed. A reassembly operation on the remaining PDU(s) is distributed and performed in the next TTI.

That is, in the case of reordering timer expiration in a specific TTI, PDU reordering by out-of-order reception of a lost PDU, or normal PDU reception without packet loss, an operation of reassembling RLC PDUs is distributed and performed during N continuous TTIs from the TTI.

Here, the maximum number of PDUs capable of being assembled into SDU one TTI, that is, MaxNumPduReassembled, may be calculated on the basis of a time taken to assemble RLC SDUs from one PDU and the assembled RLC SDUs may be transferred to the upper layer.

For example, the maximum number of PDUs capable of being processed for the reassembly in TTI=k, that is, MaxNumPduReassembled (TTI=k), is a sum of the number of PDUs capable of being basically processed in one TTI, that is, basicNumPduReassembledPerTTI (TTI=k), and the number of PDUs to be processed in one TTI among PDUs passed to a current TTI by load distribution without being processed in a previous TTI=k−1, that is, delayedNumOfPduReassembledPerTTI (TTI=k−1).

MaxNumPduReassembled (TTI=k)=basicNumPduReassembledPerTTI (TTI=k)+delayedNumOfPduReassembledPerTTI (TTI=k−1)

That is, the maximum number of RLC PDUs capable of being processed in one TTI is a sum of the number of RLC PDUs capable of being processed by normal reception in one TTI and the number of PDUs among PDUs remaining without being processed in a previous TTI due to load burden upon reordering/reassembly, that is, delayedNumOfPduReassembledPerTTI.

When the packet reordering and reassembly method according to the above-described example embodiments of the present invention is used, an RLC layer of a 3GPP LTE-Advanced mobile communication system temporally divides and performs an operation of reassembling RLC SDUs from a plurality of RLC PDUs over many TTIs in a reordering and reassembly function according to out-of-order reception due to packet loss and retransmission. Therefore, it is possible to prevent packet loss and perform high-performance data processing by distributing load occurring in one TTI to many TTIs.

While the example embodiments of the present invention and their advantages have been described in detail, it should be understood that various changes, substitutions and alterations may be made herein without departing from the scope of the invention.

What is claimed is:

1. A method of distributing and performing reordering of protocol data units (PDUs) and reassembly of service data units (SDUs) in a radio link control (RLC) layer over many transmission time intervals (TTIs), comprising:
recognizing, by an RLC entity of a reception side, a TTI start time;
initializing a count of the number of PDUs to be processed in a TTI;
processing a reordering timer by determining whether the reordering timer has expired, and performing a procedure of reassembling RLC SDUs and transmitting the reassembled RLC SDUs to an upper layer and updating the reordering timer when the reordering timer has expired;
processing reception by performing the procedure and updating the reordering timer when an RLC PDU received from a lower layer is an RLC PDU which should be received by retransmission from a transmission side before reordering timer expiration; and
processing transmission by processing RLC SDUs received from the upper layer,
wherein the procedure limits the number of RLC PDUs to be processed within a TTI using the count of the number of PDUs to be processed within the TTI.

2. The method of claim 1, wherein the recognizing includes receiving, by the RLC entity of the reception side, a TTI interrupt.

3. The method of claim 1, wherein a time allocated to the transmission processing during one TTI and a time allocated to the reception processing are configured to be variable.

4. The method of claim 1, wherein the transmission processing includes:
receiving RLC SDUs from the upper layer;
encoding the RLC SDUs into an RLC PDU; and
transferring the RLC PDU to the lower layer.

5. The method of claim 1, wherein the procedure includes reassembling RLC SDUs by using RLC PDUs of which the number is the number of RLC PDUs to be processed for the reassembly of RLC SDUs within a TTI, and transferring the reassembled RLC SDUs to the upper layer.

6. The method of claim 5, wherein the number of RLC PDUs to be processed within the TTI is calculated on the basis of a time taken to assemble RLC SDUs from one PDU and transfer the assembled RLC SDUs to the upper layer.

7. The method of claim 6, wherein the number of RLC PDUs to be processed within the TTI is calculated by a sum of a number of RLC PDUs to be processed basically within the TTI and a number of RLC PDUs passed to the TTI without being processed in a previous TTI due to load distribution.

8. The method of claim 5, wherein the procedure includes:
initializing a parameter for designating a range of a PDU sequence number (SN) indicating an RLC PDU to be processed within the TTI;
includes reassembling RLC SDUs by using RLC PDUs of which the number is the number of RLC PDUs to be processed for the reassembly of RLC SDUs within a TTI in the range of the PDU SN and transferring the reassembled RLC SDUs to the upper layer; and
setting an SN of a first RLC PDU to be processed in the next TTI.

9. The method of claim 8, wherein the reassembling includes:
determining whether to perform additional reassembly based on the number of currently processed RLC PDUs and SNs of the currently processed RLC PDUs;
reassembling RLC SDUs if the additional reassembly is determined to be performed, transmitting the reassembled RLC SDUs to the upper layer, designating an SN of the next PDU to be processed, incrementing the number of currently processed RLC PDUs, and iterating from the determining of whether to perform additional reassembly; and
setting an SN of a first RLC PDU to be processed in the next TTI if no additional reassembly is determined to be performed.

10. A method of reassembling RLC SDUs of an RLC layer and transmitting the reassembled RLC SDUs to an upper layer in which the number of RLC PDUs to be processed for a reassembly of RLC SDUs in one TTI is limited for load distribution when the PDUs of the RLC layer are reordered and the SDUs of the RLC layer are reassembled, comprising:
initializing a parameter for designating a range of a PDU SN indicating an RLC PDUs to be processed within the TTI;
reassembling RLC SDUs by using RLC PDUs of which the number is the number of RLC PDUs to be processed for the reassembly of RLC SDUs within a TTI in the range of the PDU SN and transferring the reassembled RLC SDUs to the upper layer; and
setting an SN of a first RLC PDU to be processed in the next TTI.

11. The method of claim 10, wherein the reassembling includes:
determining whether to perform additional reassembly based on the number of currently processed RLC PDUs and SNs of the currently processed RLC PDUs;
reassembling RLC SDUs while incrementing the SN of the currently processed RLC PDU if the additional reassembly is determined to be performed, transmitting the reassembled RLC SDUs to the upper layer, designating an SN of the next PDU to be processed, incrementing the number of currently processed RLC PDUs, and iterating from the determining whether to perform additional reassembly; and
setting an SN of a first RLC PDU to be processed in the next TTI if no additional reassembly is determined to be performed.
